(19) United States
(12) Patent Application Publication
(10) Pub. No.: US 2011/0094505 A1
(43) Pub. Date: Apr. 28, 2011

(54) Acid hydrolysis process of cellulosic and lignocellulosic materials

(75) Inventors: Romeo Bulla, Sao Paulo (BR); Gonzalo Sieiro Gonzalez, Vinhedo (BR); Francisco Inacio Pellegrini, Sao Bernardo do Campo (BR)

(73) Assignee: Oxiteno S.A. Industria e Comercio, Sao Paulo - SP (BR)

(21) Appl. No.: 11/816,080

(22) PCT Filed: Feb. 9, 2006
(86) PCT No.: PCT/BR2006/000019

§ 371 Date: Dec. 12, 2007

(30) Foreign Application Priority Data
Feb. 15, 2005 (BR) PI0500534-5

(51) Int. Cl. C13K 1/02

(52) U.S. Cl. 127/37

(57) ABSTRACT

The present invention relates to an enhanced process for sugar production through the acid hydrolysis of cellulosic and lignocellulosic materials characterized by the treatment of these materials in three steps. In the first step, it is made a digestion of the lignocellulosic material using a solvent capable of partially dissolving the lignin, which constitutes part of the lignocellulosic material. In the second step, the cellulosic material resulting from the treatment with the solvent is subjected to an acid treatment in such conditions that mainly hemicellulose is hydrolyzed to form a sugar solution rich with pentose monomers and oligomers. In the third step, the cellulosic material from the second step is subjected to an acid treatment in such conditions that the major part of the cellulose is hydrolyzed to form a sugar solution rich with hexose monomers and oligomers. This invention also relates to a Digestion Vessel and a Reactor, with this set being constituted by a single vessel or a set of vessels where it's possible to identify three areas where the three process steps are conducted.

The present invention relates to an acid hydrolysis process of cellulosic and lignocellulosic materials, digestion vessel and hydrolysis reactor. Sugars are obtained according to this invention through acid hydrolysis of cellulosic materials, such as paper and cardboard, and lignocellulosic materials, such sugarcane bagasse, vegetable straws and wood, using a suitable solvent to remove lignin before the hydrolysis reaction. The obtained sugars can be used as chemical intermediates or converted into ethanol that, in its turn, can be employed as fuel.

For effect of this invention, cellulosic and lignocellulosic materials are characterized as complex mixtures containing mainly cellulose, hemicellulose and lignin. In addition to the three mentioned compounds, lignocellulosic materials contain smaller proportions of proteins, oils, silica and calcium, sodium, potassium, and iron salts, among others. Cellulose, which is a glucose polimer, can be presented in proportions between 30 and 80% in weight, depending on the type of material. Hemicellulose, which is a polimer composed by units of xylose, arabinose and galactose, can be present on proportions between 20 and 40% in weight. Lignin is a complex phenolic polymer, present in natural lignocellulosic materials.

Many cellulosic and lignocellulosic materials constitute industrial and domestic residuals, which present problems of industrial or municipal waste because, although biodegradable, they can occupy big volumes in sanitary landfills. Incineration of these materials can be put in force, but its produced ashes or fumes can represent a serious restriction to this alternative. For other side, there is a growing concern with the burning of fossil fuels because of the generation of CO₂ and other gasses that tend to make the global heating worse. It is very well established that the hydrolysis of cellulosic materials produces its respective sugars. These substances can be converted into several organic products through the processes of chemical or biological conversion. The most important of these products is ethanol, which can be obtained through glucose fermentation or from pentoses deriving from hemicellulose. Ethanol can be used as liquid fuel in internal combustion engines in place of gas and diesel oil, which are fuels from fossil origin. Optionally, hexoses can be hydrogenated to obtain manitol e sorbitol, which are important chemical intermediates. The pentoses can be hydrogenated to xylitol that has sweetener properties or can be fermentated in such a way to obtain mainly methane that can be used as industrial or domestic fuel in place of the liquid petrol gas (LPG). Lignin can be the source of phenolic compounds or can be used as fuel in industrial boilers or heaters. These possibilities justify the technological effort that has been employed, for some decades, to obtain technical and economically viable processes for the hydrolysis of cellulosic and lignocellulosic materials in such a way to obtain corresponding sugars.

The cellulose and hemicellulose hydrolysis can be made at room temperature using enzymes as catalysers. The enzymes are more selective. In the case of lignocellulosic materials, however, cellulose and hemicellulose fibers are encapsulated by structures composed by lignin, which are chemically more resistant and make difficult to access enzymes, rendering slower its action. Additionally, the formed sugars tend to inhibit the catalytic action of enzymes limiting this way the concentrations that can be obtained. An alternative has been conducted the sugar fermentation to form ethanol, but it restricts the process application exclusively for the production of ethanol. These limitations allied to the high cost of enzymes commercially available render processes of enzymatic hydrolysis not much attractive by an economic point of view.

The catalytic activity of strong acids for reactions of cellulose and hemicellulose hydrolysis is known for more than one century. The use of concentrated sulphuric acid to promote hydrolysis of cotton cellulose was documented for the first time in 1883. In 1918, it was proposed by researchers of the United State Department of Agriculture a process for the production of sugars and other products from corn seed fibers, in two stages, using diluted sulphuric acid in the first one and concentrated acid in the second one. In 1937, in Germany, it was operated the first industrial unit of catalyzed wood hydrolysis by hydrochloric acid. In 1948, it was developed in Japan a hydrolysis process using concentrated sulphuric acid. Sugars produced by the hydrolysis reaction were separated from the acid passing the mixture through membranes. More recently, the hydrolysis process based on the use of concentrated acids was enhanced, being proposed the use of ion exchange resins to separate the solution acid from sugars by means of chromatographic processes. HESTER and HESTER & FARINA related processes of this nature in the U.S. Pat. No. 5,407,580, published on Apr. 18, 1995, and number U.S. Pat. No. 5,538,637, published on Jul. 23, 1996, respectively.

Processes using concentrated sulphuric acid have the advantage of operating in relatively low temperatures (80 to 100° C.) as showed by FARONE in the U.S. Pat. No. 5,562,777, published on Oct. 8, 1996. The use of concentrated acid, however, suffers some inconveniences, such as low yield in sugars, and the necessity of relatively high investments in the chromatographic system of sugar separation and in the acid re-concentration unit. Moreover, the acid re-concentration process consumes big quantities of energy.

Processes using diluted acids do not require acid separation and re-concentration. Additionally, with diluted acids it is possible to use cheaper materials to build equipments. Processes of such type have been described since the end of XIX century. It is known that hemicellulose can suffer acid hydrolysis in relatively mild conditions for acid temperature and concentration. In counterpart, cellulose is sufficiently resistant to acid hydrolysis, requiring longer contact times and higher temperatures. When it is used sulphuric acid, the more frequently indicated concentrations are from 0.5% to 3% and the temperatures are between 130° C. and 260° C. That, however, can be a serious inconvenience because these conditions can favor parallel reactions, particularly sugar decomposition, reducing the process yield.

One example of the hydrolysis processes of cellulosic and lignocellulosic materials catalyzed by diluted acids is described by BRELSFORD in the U.S. Pat. No. 5,411,594, published on May 2, 1995. This process is conducted in two stages. In the first stage, the cellulosic material, along with recycled liquid of the second stage, is introduced, under pressure, in a cased reactor externally heated with steam where is kept a temperature between 135 to 195° C. and a residence time between 1 and 20 minutes. The liquid reactor effluent, containing pentoses and hexoses, constitutes the process product. The solid part is separated, receives a solution of sulphuric acid, and follows for the second stage what is also an externally heated cased reactor, operated between 165 and 260° C., with a residence time between 0.5 and 20 minutes. The second stage effluent is separated in two currents. The solid current is composed essentially of lignin and non-hydrolyzed cellulose. The liquid current, containing acid and cellulose hydrolizate is recycled for' the first stage. In the patent of BRELSFORD, it is also described depressurization schemes of reactor effluents, made with the objective of reducing the material temperature before perform the respective separations and utilization ways of the steam produced in the depressurization systems. In the typical example presented in the patent, it is indicated a yield of 86.6% related to pentoses and 79% related to hexoses. According to the publication of the United States Department of Energy that presents the process described in the patent of BRELSFORD in “The BEI Cellulose Hydrolysis Process and Reactor System (BEI CHP&RS)” of August 2002, the conversation is from 70 to 80% of hemicellulose in the first stage and from 60 to 70% of cellulose in the second one.

As previously noted, the use of diluted acid requires more elevated temperatures and longer reaction times, when compared to the processes using concentrated acid. This can be a serious inconvenience because the permanence of sugars by relatively long times, in high temperatures, can promote a significant decomposition of these sugars, leading to the formation of several by-products. The dehydratation of pentoses produces mainly furfural while the dehydratation of the hexoses produces 5-hydroxymethylfurfural. The lignin itself can partially decompose forming aromatic alcohols. Other by-products of sugars resulting from decomposition are observed, such as acetic acid and methanol, which reduce the process yield. Besides, when sugars are used for producing ethanol by fermentation, these sub-products can act as growth inhibitors and microorganism activity.

Other inconvenient of the processed using acids in concentrations over 1% is the relatively high quantity of alkali required to neutralize the sugar solution and the necessity of effluent discard that result in the neutralization. When sulphuric acid is used as catalyser of hydrolysis reactions and limewater as neutralizing agent, it is formed hydrated calcium sulfate, which is solid. Although this material founds application in civil construction, big quantities cannot find consumption and become a serious problem for disposal.

An alternative for the hydrolysis processes of cellulosic materials is to combine acid hydrolysis with the enzymatic hydrolysis. In this case, the first stage, also called pretreatment stage, is generally an acid hydrolysis. The conditions are such that all hemicellulose and part of cellulose are hydrolyzed. The hydrolizate is then separated from the residual solids, which contain mainly lignin and cellulose. This solid material undertakes enzyme action (cellulases), which hydrolyzes the cellulose molecules. A process presenting these characteristics is on development in the US Department of Energy's (DOE) Renewable Energy Laboratory (NREL), in the Biomass Program: “The DOE Bioethanol Pilot Plant A Tool for Commercialization” DOE/GO-10200-1114, September, 2000. The pretreatment equipment described in this publication is constituted by a horizontal and a vertical cylindrical body in the interior from which the mixture movement of the biomass and the acid solution is promoted by the action of threads assembled around the coaxial axis with the cylindrical bodies. The separation of the hydrolizate from the residual solids that leave the pretreatment reactor requires the use of filters built from materials resistant to acid used as catalyst. After washed, solids can then be subjected to enzymatic hydrolysis.

The process described above has the inconvenience of high energy necessary to feed the cellulosic material and the high investment required for building reactors, filters and ancillary equipments that contacts the acid solution. These factors, in addition to other ones such as high cost of enzymes used in the enzymatic hydrolysis stage, have hampered the commercial use of these processes for lacking of economic viability.

An additional serious difficulty observed in the hydrolysis processes of lignocellulosic materials is the presence of lignin. This substance has a rigid physical structure and is chemically very resistant. Lignin involves polysaccharide currents, making difficult to access enzymes and diluted acids that catalyze the hydrolysis. Many processes have been proposed for treating cellulosic materials before or during hydrolysis processes. The explosion with steam is one of the most cited. FUNK, for example, in the U.S. Pat. No. 4,070,232 of Jan. 24, 1978, describes a pre-hydrolysis process in presence of a chloridric, formic or acetic acid and water steam. Although efficient as a way to reduce the lignin inhibiting action, the process described by FUNK has the inconvenience of consuming great quantities of energy and generating considerable quantities with acid-contaminated steam, which presents a difficult reutilization. Other alternatives have been proposed. It is well known that certain organic compounds can dissolve lignin from lignocellulosic materials. KLEINERT et al, in the U.S. Pat. No. 1,856,567 published on May 3, 1932, have already proposed the use of acid solutions of alcohols, particularly ethanol, in high pressures and temperatures over 150° C. to remove lignin from wood. However, the contact time (two steps with 3 hours each) is excessively long for a practical application of the process such as originally described. PASZNER and CHANG, in the U.S. Pat. No. 4,470,851, published on Sep. 11, 1984, describe a process of “quick” hydrolysis of lignocellulosic materials with simultaneous lignin dissolution using a concentrated aqueous solution of acetone, containing small quantities of acid. The dissolution and hydrolysis are conducted to a temperature preferably between 160 and 210° C. with an acid concentration between 0.05 and 0.5% in weight. Similar process is described by HILST in the Brazilian patent PI 9600672-2 A, published on Dec. 30, 1997 (RPI 1410). The hydrolysis reactor described by HILST is a stainless steel vertical vessel. The feeding of lignocellulosic material is made at the top, keeping a descendant flow along the reactor. An aqueous solution, containing a solvent, typically ethanol, water and catalyst is fed through vertical concentric piping installed in the reactor center and distributed through sprinkler holes. The reactor also is provided from several systems of external liquid recirculation, which is removed through filtration screens and returned through piping concentric to feeding pipes of the solvent acid solution. The removal of liquids is made in the recirculation systems, containing lignin and soluble sugars, essentially pentoses and hexoses. These currents are subjected to a flash evaporation that rapidly reduces the temperature and separates part of the solvent. The rest of the solvent is separated by distillation. Lignin, insoluble in the remnant sugar solution, is then separated by decantation. It is indicated a recovery of up to 85% of the sugars after a contact time of 10 to 40 minutes and a temperature from 160 to 250° C. From the process analysis described by HILST, it is understood that practically all lignin and the cellulosic material are solubilized, remaining only mineral material, which is deposited at the bottom of the reactor. Processes described by PASZNER and CHANG and by HILST, taken here as reference, are typical from the processes described in the state-of-art, being characterized by lignin solubilization with reactions of cellulose and hemicellulose hydrolysis.

It was now discovered that the processes based on the use of lignin solvents can present bigger yields if the lignin dissolution step, hemicellulose acid hydrolysis and cellulose hydrolysis were conducted in distinct steps, in separated vessels, or in the single vessel with restricted for each step. The operation in separated steps was observed to optimize the conditions occurring in each step and, thus, optimize the process as a whole, obtaining sugar yields bigger than those described in the previous art.

The present invention relates to process for obtaining sugars by acid hydrolysis of cellulosic and lignocellulosic materials characterized by the fact that comprise the steps:

(a) lignin dissolution: step where it is performed the lignin dissolution;
(b) pre-hydrolysis: step where it is conducted mainly the hemicellulose hydrolysis;
(c) cellulose hydrolysis;
being that the steps above can happen separately or distinctly, in this order or in which step (b) comes first than step (a).

Although there are several arrangement options to conduct the several steps, the preferred arrangement, according to this invention, is a sequence in that first it is performed the lignin dissolution, then it is conducted mainly hemicellulose hydrolysis (pre-hydrolysis) and finally it is made cellulose hydrolysis. Preferably the solid material currents effluent from the first and second steps are washed out with water in such a way to minimize the contamination of the following steps with the compounds prevailing in the previous steps. The lignin solution and the sugar solution are obtained in distinct currents and optionally the sugar current rich in pentoses monomers and oligomers to be obtained separately from sugar current rich in hexose monomers and oligomers.

Characteristics bringing the main benefits of the process focused in this invention are:

a) conduct the first step (lignin dissolution) in conditions such as hemicellulose or cellulose hydrolysis rate is minimal and separate the major part of lignin solution before feeding the cellulosic material for the pre-hydrolysis step;

b) conduct the pre-hydrolysis step in relatively mild conditions for acid concentration and temperature and separate partial or totally the sugar solution (monomers and oligomers) before feeding the residual cellulosic material to the cellulose hydrolysis step;

c) conduct the cellulose hydrolysis step in more severe conditions for acid concentration and temperature and remove the sugar solution (monomers and oligomers) as an isolated current or a current mixed to the sugar current deriving from the pre-hydrolysis step.

1. The lignin dissolution step can be conducted using suitable solvents and conditions favoring the action of these solvents at the same time in which minimize the hemicellulose hydrolysis. The preferred solvents, according to the objective of this invention, include: ketones such as acetone, methyl ethyl ketone and methyl isobutyl ketone, or its mixtures, in neutral or slightly acid media; aliphatic alcohols and glycols such as methanol, ethanol, 1-propanol, 2-propanol, 1-butanol, 2-methyl-1-butanol, 1-pentanol, 2-methyl-1-butanol, 3-methyl-1-butanol or ethyl, propil and butyl glycols, and its mixtures, in neutral, alkaline or slightly acid media; ketone mixtures, aliphatic alcohols and/or glicols in neutral or slightly acid media and its mixtures in neutral, alkaline or slightly acid media; mixtures of ketones and aliphatic alcohols and/or glycols in neutral or slightly acid media. These solvents being either anidrous or, preferably, in aqueous solutions. The temperature range required for lignin dissolution is from around 70 to around 200° C. The preferably employed solvent is the ethanol in aqueous solution.

During the lignin dissolution step, the temperature is kept in the range from around 70 to around 200° C., being that the major part of the lignin solution is separated from the residual solids right after the formation of the referred solution.

The cellulosic material obtained after the lignin dissolution step is subjected to a water washing or, optionally, a diluted sugar solution, in countercurrent, in such a way to eliminate the major part of the solvent dragged by the cellulosic material. Particularly it can happen washing water injection in countercurrent of the residual material obtained after cellulose hydrolysis after removing the referred residual reactor material, in such a flowing that apart from the present sugar concentration in the solution that leaves the cellulose hydrolysis solution is between around 5 and around 35% in weight The dissolution step happens in the digestion vessel with the following characteristics:

vertical cylindrical shape preferably;

the feeding area of the lignocellulosic material and solvent is located in one of its tips;

the digestion vessel can be provided from a separation device and liquid removal, which constitutes the lignin solution;
the digestion vessel cane be provided by a feeding and water distribution device or, optionally, of diluted sugar solution, immediately before the exit tip of the cellulosic material.

The process according to the invention employs preferably reactor in which is conducted the pre-hydrolysis step and the hydrolysis step of cellulosic and lignocellulosic materials for obtaining sugars, being it is presented in the form of a vessel or a set of cylindrical, conical or partially cylindrical or partially conical vessels serially interlinked, being that the cellulosic or lignocellulosic material is fed in one of its tips and the residual material removed in the opposed tip, and where it can be identified: (a) a pre-hydrolysis area or vessel; (b) a hydrolysis area or vessel; (c) a washing area of the residual material after the hydrolysis area. It is employed preferably vertical vessels, being that the area of pre-hydrolysis is preferably cylindrical and the area of hydrolysis is preferably partially cylindrical and partially cylindrical and partially conical.

The steps of hemicellulose and cellulose steps are conducted in acid media. Inorganic acids such as sulphuric, nitric, phosphoric and hydrochloric are effective to obtain these conditions. Sulphuric acid and nitric acid are preferred. When these acids are used, it is required concentration ranges between 0.1 and 2.0 g/L with temperatures between 70 and 200° C., preferably between around 100 to around 160° C. and a residence time of 1 to 20 minutes in the pre-hydrolysis step and concentrations between 0.2 and 4.0 g/L, with temperatures between 130 and 250° C., preferably between around 130 to around 200° C., for a residence time of 2 to 40 minutes, in the hydrolysis step.

The pre-hydrolysis step is conducted in relatively mild conditions for acid concentration and temperature and of which the sugar solution, mainly pentose monomers and oligomers is separated before feeding the cellulosic material for the following steps, obtaining a yield in sugars superior to 85% from which theoretically could be obtained from the hydrolyzed cellulosic material, being possible to reach 95% if the conditions were optimized.

The step of cellulose hydrolysis is conducted in more severe conditions that the pre-hydrolysis step for acid concentration and temperature and by the fact that the sugar solutions, mainly hexose monomers and oligomers, is removed as an isolated current or, optionally, in mixture with the sugar current deriving from the pre-hydrolysis step, obtaining a yield in sugars superior to 85% from which theoretically could be obtained from the hydrolyzed cellulosic material.

The invention also relates to digestion vessel employed in the lignin dissolution step, of vertical cylindrical aspect, to which is fed with lignocellulosic material and solvent in one of its tips, being provided a liquid removal device separated from the solids through which is removed the lignin solution and of a feeding and water distribution device or, optionally, of diluted sugar solution, immediately before the exit tip of the cellulosic material.

The invention also relates to reactor in which is conducted the pre-hydrolysis step and the step of cellulosic and lignocellulosic material hydrolysis for obtaining sugars characterized by the fact that it is a vessel or a set of cylindrical, conical or partially cylindrical or partially conical vessels serially interlinked, being that the cellulosic or lignocellulosic material is fed in one of its tips and the residual material removed in the opposite tip, and where can be identified: (a) an pre-hydrolysis area or vessel; (b) a hydrolysis area or vessel; (c) a washing area of the residual material after the hydrolysis area. Preferably this cylindrical or partially cylindrical and partially conical vertical vessel receives feeding of cellulosic material in the upper tip and the residual material is removed in the lower tip, or also can receive the feeding of the cellulosic material in the lower tip and the residual material is removed in the upper tip.

Some complementary characteristics on the reactor according to the invention:
to the ending of the pre-hydrolysis area, there is at least one solution withdrawal that contains sugars formed in the pre-hydrolysis area and, optionally, of sugars formed in the hydrolysis area located immediately after the pre-hydrolysis area;
after the pre-hydrolysis, there is a optional washing area of the cellulosic material before to be fed for a cellulose hydrolysis area;
next to the beginning of the area of cellulose hydrolysis, there is at least one solution withdrawal which contains sugars formed in the hydrolysis area and, optionally, of part of or the whole solution of sugars formed in the pre-hydrolysis;
the beginning of the pre-hydrolysis area is defined by an acid injection system, being this acid distributed along the reactor horizontal section;
the end of the hydrolysis area of cellulose hydrolysis is defined by an acid injection system, being this acid distributed along the reactor horizontal section;
the washing water or, optionally, a diluted sugar solution, is fed to a sufficiently high temperature in such a way to reduce or eliminate the necessity of heat supply through recirculation through the external heater or by the introduction of live steam;
immediately before the exit tip of the residual material, it is made a water injection being this water distributed along the horizontal section corresponding to the entrance point, in such a way that: (a) part of the water flows in countercurrent with the residual material deriving from the cellulose hydrolysis area, constituting after the media where sugars formed in this area are dissolved; (b) the remnant of the water follows along with the residual material deriving from the cellulose hydrolysis area and leaves the reactor, being that:
in a point between the end of the area of hydrolysis and the injection section of washing water of the residual material can be made, optionally, a liquid heating that pass between these points;
the heating can be made, optionally, by liquid recirculation, impelling by a pump, through an external heater to the Reactor, and where the heated liquid returns to the reactor;
the heating can be made optionally by live steam injection.
the heat supply by liquid recirculation through an external heater or by the injection of live steam can be reduced or eliminated if the washing water of the residual material is at a sufficiently high temperature for the required conditions in the cellulose hydrolysis area;

The following examples have only an elucidating nature and shall not been taken for limiting effects of the invention.

### EXAMPLE 1

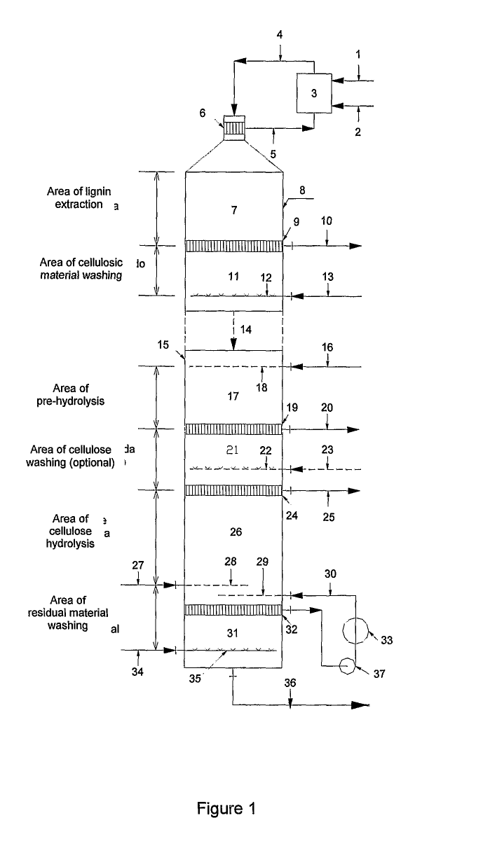

The process focused on this invention, in its preferred form, is described in this paragraph with the aid of FIG. 1: The cellulosic material (1) and solvent (2) are mixed and heated in a feeding system (3). The lignocellulosic material and solvent mixture, pre-heated to optimal temperature for lignin extraction, is fed continuously through the current (4) for the Digestion Vessel (7), which is a vertical cylindrical vessel. A part of the solvent is removed through a metallic screen (6) and returned to the mixer (3) through the piping (5). Optionally, the solvent feeding can be mixed with the recycle current (5) before to be sent to the feeding system (3). Also optionally, the solvent pre-heating can be made passing the cycle current (5) through a heat exchanger (not presented in FIG. 1). The Digestion Vessel assembly (8) can be made in such a way that the lignocellulosic material is fed by its upper tip or, optionally, by its lower tip. The feeding temperature of the lignocellulosic material and solvent mixture shall be between 70 and 200° C., depending on the fed lignocellulosic material and the used solvent. The lignocellulosic material and solvent mixture passes through the area of lignin extraction (7) where it takes place the lignin dissolution contained in the lignocellulosic material. It is not necessary that the entire lignin is completely dissolved, but only enough to warrant a suitable rate of cellulose and hemicellulose hydrolysis in the ulterior steps. Additionally, the conditions in the Area of lignin extraction shall be such that hemicellulose hydrolysis is minimum, in such a way to reduce the quantity of sugars contained in the aqueous effluent obtained after the solvent recovery and lignin separation. The optimal degree of lignin extraction will depend on the lignocellulosic material fed to the Digestion Vessel. The lignin solution is removed by the Digestion Vessel through an existing device in the interior or in the Digestion Vessel wall to the end of lignin digestion. This device is provided with a metallic screen that allows only the solution to pass, keeping the solid material in the interior of the reactor. An external or internal ring (9) collects the solution that is conducted to the piping (10) to where it is removed. The cellulosic material subjected to the treatment with solvent leaves the area of lignin extraction and enters the washing area (11) where it is washed in countercurrent with part of the water injected in the Digestion Vessel through piping (13) and is distributed through the distributor (12). The washing water injected through the current (13) can, optionally, be the recovered current after the separation of lignin and solvent. The washed cellulosic material leaves the Digestion Vessel through the piping (14) and feeds the Reactor (15), which is a vertical cylindrical vessel. Part of the water injected through the piping (13) follows along with the cellulosic material that leaves the Digestion Vessel. If the cellulosic material contains a low contents of lignin, the digestion step and, consequently, the Digestion Vessel cannot be necessary. In this case, the cellulosic material can be mixed with water and fed directly to the Reactor (15). The temperature of the water fed through piping (13) is adjusted in such a way to obtain an optimal temperature in the pre-hydrolysis area (17) of the Reactor (15). The adjustment of this temperature in the as lower value as possible is convenient to minimize the decomposition rate of formed sugars. Temperatures between 70 and 200° C., preferably between 100 and 160° C. are generally sufficient. If for convenience, it can be used an external heat exchange to adjust the temperature in the pre-hydrolysis area. In this option, not presented in FIG. 1, part of the liquid leaves the washing area of the cellulosic material (6) can be removed in the Digestion Vessel exit or Reactor entrance (15) through holes in the wall with screens and an external collector, as previously described. Using a pump, the collected liquid can be cooled or heated in a heat exchanger and then returned to the Reactor (15). This Reactor can be constituted by one single vessel where it is performed the steps of pre-hydrolysis and hydrolysis of the cellulosic material or constituted by two distinct vessels (8) and (15), interlinked by piping (14). In the entrance of the pre-hydrolysis entrance (17), the cellulosic or lignocellulosic material receives an acid solution fed through piping (16) and distributed through the distributor (18). If it is used sulphuric acid, a concentration between 0.1 and 2.0 g/L in the pre-hydrolysis area and a residence time between 1 and 20 minutes are generally sufficient, for a temperature range between 70 and 200° C., depending on the characteristics of the cellulosic material. In the pre-hydrolysis area (17), the biggest part of hemicellulose, and a small part of cellulose are hydrolyzed forming monomers and oligomers of pentoses and hexoses. In addition to temperature, acid concentration and residence time, another variable that can affect the process yield is the ratio between water flowing and cellulosic material flowing that passes through the pre-hydrolysis area. The bigger is this relation, lower will be the average concentration of sugars in the pre-hydrolysis area, which favors the process yield. However, very diluted solutions can cause higher costs in the posterior processes of treatment or chemical or biochemical conversion of the sugar solution obtained. The Optimal range of concentration is a variable that shall be optimized in a case-by-case basis. The water/cellulosic material rate, considering the washing water optionally introduced through piping (23), is chosen in such a way that the total sugar concentrations in the exit of the pre-hydrolysis area is between 3 and 35% in weight. To the end of the pre-hydrolysis area, the sugar solution can be mixed to a part to the entire sugar solution that comes from the area of cellulosic hydrolysis (26), being the resulting mixture collected by the collector (19) and removed by the system through piping (20). If it is wished that the sugar solution formed in the pre-hydrolysis area is removed separately from the sugar solution formed in the hydrolysis area, then it can be collected by the collector (19) and removed by piping (20) while the sugar solution deriving from the hydrolysis area is collected by the collector (24) and removed by the Reactor through piping (25). In the case in which the formed solutions in the pre-hydrolysis area and in the cellulosic hydrolysis area are removed separately as described above and is wished to minimize the drag of sugars formed in the pre-hydrolysis area to the hydrolysis area, then the cellulosic material that leaves the Pre-hydrolysis area is washed out with water introduced by piping (23) and distributed by the distributor (22). Optionally, the mixture deriving from the area (17) can be mixed to the sugar solution deriving from the cellulose hydrolysis area (26), being the resulting mixture collected by the collector (24) and removed through piping (25). In addition to the collectors and piping indicated in FIG. 1, through which are removed the sugar currents produced in the Pre-hydrolysis area and in the Cellulose hydrolysis area, can exist other collectors and removal piping, with the objective of altering the effective volumes of pre-hydrolysis and hydrolysis. The solid cellulosic material not converted in the Pre-hydrolysis area (17) allows to the Cellulose hydrolysis area (26). In its interior, it takes place the cellulose hydrolysis catalyzed by an acid. The solution, which contains acid, flows in countercurrent with the cellulose flow. The sugars formed in this area can be incorporated to those formed in the area (17), resulting from pre-hydrolysis, constituting the final product removed through piping (20). Optionally, a part or the entire sugar solution deriving from the hydrolysis area can be removed from the Reactor through the collecting ring (24) and removed through piping (25), along with part of the solution deriving from the area (17). Usually it is necessary a temperature between 130 and 250° C., preferably between 130 and 200° C., to assure a cellulose conversion over 90% with a residence time between 2 and 40 minutes. Very low temperatures are preferable to minimize the sugar decomposition rate. The temperature in the area (26) is adjusted by heating of a current of liquid removed from the bottom of the reactor by the collecting ring (32), being boasted by the Pump (37) through the Heater (33), and returned to the reactor through the piping (30), where is distributed through the distributor (29). The acid used as catalyser is fed in the lower extreme of the area (26) through the piping (27) and distributed through the distributor (28). If it is used sulphuric acid, it is necessary to keep a concentration between 0.2 and 4.0 g/L in the cellulose hydrolysis area. The material leaving the lower extreme of the area (26) is constituted by cellulose and other types of organic matter (including lignin and small portions of sugars) in addition to mineral compounds not dissolved in the Reactor. It is not essential that the entire cellulose is converted, since the remaining one remaining can be treated and returned to the Reactor, but it is generally possible to convert over 90% of fed cellulose. The material leaving the area (26) goes to the area (31), which the washing area of the residual material where it is removed the biggest part of the acid and the sugars retained in the residual solid material. Water is introduce through piping (34) and distributed in the Reactor through the distributor (35). Part of this water flows in countercurrent to the residuals. The portion of water following in countercurrent with the residual material will determine sugars leaving the area (26). The bigger the flow is in relation to the cellulosic material flow that enters the area (22), smaller will be the sugar concentration, which favors the process yield. However, excessively low concentrations of sugars can cause elevated costs to its recovery or utilization in ulterior processes. Thus, this flow is chosen in such a way that the total sugar concentration in the solution that leaves the area (26) remains between 5 and 35% in weight. The solid residual material is removed from the Reactor in suspension in water through piping (36). This material can be neutralized (preferably with a sodium hydroxide solution), cooled, washed to remove salts and, eventually, returned to the reactor, since it is made a purge to eliminate non hydrolyzable or insoluble solid materials in water or in lignin solvent. These operations are not presented in FIG. 1. The above-described process and the Reactor allow to obtain a yield superior to 85% of the corresponding to the total of the converted cellulosic material (cellulose and hemicellulose). In optimal conditions, this yield can overcome 95%.

Other system construction options, not showed in FIG. 1, can be used, without damage to the merit of this invention, such as:
The lignocellulosic material can be fed to the reactor through an independent system of solvent feeding or mixed with part of the solvent. In this case, the other part of the solvent can be optionally fed in countercurrent with lignocellulosic material flow.
The Digestion Vessel (8) and the Reactor (15) can constitute a single equipment. In this case, the cellulosic material pass directly from the washing area to the pre-hydrolysis area, with no need to interlink piping (24).
Reactor (15) can be a single vessel or a set of vessels in which are conducted the steps of cellulose pre-hydrolysis and hydrolysis. If two vessels were used, the pre-hydrolysis step will conducted in the first the cellulose hydrolysis in the second. In this case, the two vessels will be connected by a piping through which the cellulosic material leaves the first vessel the two vessels will be connected by a piping through which the material will feed the second one.
Reactor (15) can have different diameter sections in the cellulose pre-hydrolysis and hydrolysis areas, as well as in the washing zones of the cellulosic material and of residual material washing. Additionally, the forms of these areas can be totally cylindrical or partially cylindrical and partially conical.
The liquid distributor (29) showed in FIG. 1 can be located below the liquid collector (32).
The heating of the reactor contents can be performed through live steam injection opposite to the use of indirect heating system in the Heat Exchanger (33) and its ancillary devices, as showed in FIG. 1.
The necessity for heat supplied by the indirect heating system as well as the live steam injection can be reduced if the washing water fed through the piping (34) showed in FIG. 1 are at a sufficiently high temperature for the required conditions in the area of cellulose hydrolysis.
The lignocellulosic material and solvent mixture can be fed by the upper or lower tip of the Reactor (15), with the residual material being removed at the opposed tip.

### EXAMPLE 2

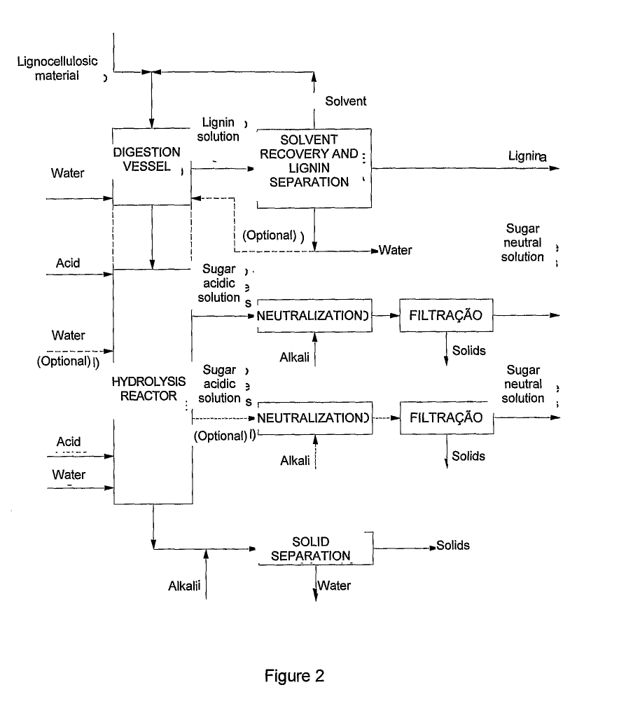

Annexed FIG. 2 presents the process integration subject of this invention in the complete system that includes the solvent recuperation, the sugar solution treatment and discard point of effluents, which will be described next. The objective of this description is to illustrate a form of application of the process for obtaining sugars by acid hydrolysis of cellulosic and lignocellulosic materials and the hydrolysis reactor.

The lignin solution leaving the reactor follows to a solvent recovery system, lignin separation and removal of the major part of water introduced in the process. Details for the system depend on the type of solvent used, relation between water and solvent present in the mixture and energy consumption needed for performing the separation. For suitable solvents to the process subjected of this invention, the mixture separation processes of these solvents with water and solid materials are known in the state of art and do not constitute part of the object of this invention. However, given the characteristics of the process and the Digestion Vessel that constitute the object of this invention, the solvent recuperation and the lignin and water separation are made without the presence of significant big quantities of acid or residual sugars, which simplifies the separation operations and allows the use of cheaper equipments, since they are required special materials. Even small sugar quantities deriving from hemicellulose hydrolysis in the lignin digestion area can be recovered if the solution is used as washing water of the residual cellulosic material after lignin digestion (Current (13) presented in FIG. 1).

Sugar currents removed from the Reactor contain small quantities of acid, products of sugar decomposition and solvent traces. These current demand only an acid neutralization and solid material separation, as showed in FIG. 2. When it is used sulphuric acid to catalyze hydrolysis of cellulosic materials in the reactor and limewater to perform neutralization of this acid in the sugar currents removed from the reactor, it is formed calcium sulfate, preferably in the hydrated form, that can be separated by filtration. The neutralization and filtration operations are also known in the actual technic and, although they do not constitute part of this invention.

The residual solid current removed from the ReactOr contains small quantities of acids. This current demands only an acid neutralization and separation of solid materials, as showed in FIG. 2. When it is used sulphuric acid to catalyze hydrolysis of cellulosic materials in the reactor and limewater to perform neutralization of this acid in the sugar currents removed from the reactor, it is formed calcium sulfate in the hydrated form, that can be separated by filtration. The neutralization and filtration operations are also known in the actual technic and, thus, do not constitute part of the object of this invention.

1-44. (canceled)

45. Acid hydrolysis process of cellulosic and lignocellulosic materials characterized by the fact that it comprises the following successively steps:
(a) lignin dissolution: step where it is performed the lignin parcial dissolution utilizing an organic solvent wherein hemicellulose or cellulose hydrolysis rate is minimum and separate the highest portion of lignin solution before feeding the cellulosic material to the pre-hydrolysis step;
(b) pre-hydrolysis: step where it is mainly conducted the hemicellulose hydrolysis utilizing a dilute acid wherein the pre-hydrolysis is conducted in relatively mild conditions for acid concentration and temperature and separate partial or totally the sugar solution (monomers and oligomers) before feeding the residual cellulosic material for the cellulose hydrolysis step;
(c) cellulose hydrolysis utilizing a dilute acid wherein the cellulosic hydrolysis step in more severe conditions for acid concentration and temperature and remove the sugar solution (monomers and oligomers) as an isolated chain or mixed with the sugar chain deriving from the pre-hydrolysis step;
where the steps above can happen separately or in a distinct way, in this order or in an order where step (b) comes first than step (a).

46. Process for obtaining sugars by acid hydrolysis of cellulosic and lignocellulosic materials according to claim 45 characterized wherein the lignin solution and the sugar solutions are obtained in separated currents.

47. Process for obtaining sugars by acid hydrolysis of cellulosic and lignocellulosic materials according to claim 45 characterized wherein optionally the sugar current rich in pentose monomers and oligomers is obtained separately from the sugar current rich in hexose monomers e oligomers.

48. Process for obtaining sugars by acid hydrolysis of cellulosic and lignocellulosic materials according to claim 45 characterized wherein the effluent solid material currents of the first and second steps are washed out with water or optionally with a diluted sugar solution.

49. Process for obtaining sugars by acid hydrolysis of cellulosic and lignocellulosic materials according to claim 45 characterized wherein the lignin dissolution step is made using a solvent chosen from ketones such as acetone, methyl ethyl ketone and methyl isobutyl ketone, or its mixtures, in neutral or slightly acid media; aliphatic alcohols such as methanol, ethanol, 1-propanol, 2-propanol, 1-butanol, 2-methyl-1-butanol, 1-pentanol, 2-methyl-1-butanol, 3-methyl-1-butanol or ethyl, propil and butyl glycols, and its mixtures, in neutral, alkaline or slightly acid media; mixtures of ketone, aliphatic alcohols and/or glicols in neutral or slightly acid media and its mixtures in neutral, alkaline or slightly acid media; mixtures of ketones and aliphatic alcohols in neutral or slightly acid media, with these solvents being either anidrous or, preferentially, in aqueous solutions.

50. Process for obtaining sugars by acid hydrolysis of cellulosic and lignocellulosic materials according to claim 49 characterized wherein it is employed preferentially ethanol.

51. Process for obtaining sugars by acid hydrolysis of cellulosic and lignocellulosic materials according to claim 45 characterized wherein the temperature in the lignin dissolution step is chosen in the range around 70 to around 200° C.

52. Process for obtaining sugars by acid hydrolysis of cellulosic and lignocellulosic materials according to claim 51 characterized wherein the cellulosic material obtaining after the lignin dissolution step is subjected to a water washing or, optionally, a diluted sugar solution, in countercurrent, in such a way to eliminate the major part of the solvent dragged by the cellulosic material.

53. Process for obtaining sugars by acid hydrolysis of cellulosic and lignocellulosic materials according to claim 45 characterized wherein the major part of the lignin solution is separated from the residual solids soon after the formation of the referred solution.

54. Process for obtaining sugars by acid hydrolysis of cellulosic and lignocellulosic materials according to claim 53 characterized wherein it is made a water injection or, optionally, a diluted sugar solution, after the cellulosic material washing obtained after the lignin dissolution, in such flowing that the sugar solution leaving the hemicellulose hydrolysis step is between 5 and 35% in weight.

55. Process for obtaining sugars by acid hydrolysis of cellulosic and lignocellulosic materials according to claim 45 characterized wherein the cellulosic material obtaining after the lignin dissolution step is subjected to a water washing or, optionally, a diluted sugar solution, in countercurrent, in such a way to eliminate the major part of the solvent dragged by the cellulosic material.

56. Process for obtaining sugars by acid hydrolysis of cellulosic and lignocellulosic materials according to claim 45 characterized wherein it is made a water injection or, optionally, a diluted sugar solution, after the cellulosic material washing obtained after the lignin dissolution, in such flowing that the sugar solution leaving the hemicellulose hydrolysis step is between 5 and 35% in weight.

57. Process for obtaining sugars by acid hydrolysis of cellulosic and lignocellulosic materials according to claim 45 characterized wherein it is employed a reactor where is conducted the pre-hydrolysis and the hydrolysis step of cellulosic and lignocellulosic materials for obtaining sugars, it is presented in the form of a vessel or a set of cylindrical, conical or partially cylindrical or partially conical vessels serially interlinked, being that the cellulosic or lignocellulosic material is fed in one of its extremities and the residual material is removed from the opposite extremity, and where can be identified: (a) a pre-hydrolysis area or vessel; (b) a hydrolysis area or vessel; (c) an area of residual material washing after the area of hydrolysis.

58. Process for obtaining sugars by acid hydrolysis of cellulosic and lignocellulosic materials according to claim 57 characterized wherein the temperature in the pre-hydrolysis step is located between around 70 and around 200° C., preferably between around 100 and around 160° C.

59. Process for obtaining sugars by acid hydrolysis of cellulosic and lignocellulosic materials according to claim 45 characterized wherein the pre-hydrolysis step is conducted in current parallel with an acid solution, being that acids such as sulphuric, nitric, phosphoric and hydrochloric can be used.

60. Process for obtaining sugars by acid hydrolysis of cellulosic and lignocellulosic materials according to claim 59 characterized wherein it is employed sulphuric acid and nitric acid.

61. Process for obtaining sugars by acid hydrolysis of cellulosic and lignocellulosic materials according to claims 59 characterized wherein the acid concentrations can vary between around 0.1 to around 2.0 g/L, for a residence time between 1 and 20 minutes.

62. Process for obtaining sugars by acid hydrolysis of cellulosic and lignocellulosic materials according to claim 45 characterized wherein the acid concentrations can vary between around 0.1 to around 2.0 g/L, for a residence time between 1 and 20 minutes.

63. Process for obtaining sugars by acid hydrolysis of cellulosic and lignocellulosic materials according to claim 45 characterized wherein the temperature in the pre-hydrolysis step is located between around 70 and around 200° C., preferably between around 100 and around 160° C.

64. Process for obtaining sugars by acid hydrolysis of cellulosic and lignocellulosic materials according to claim 45 characterized wherein the hydrolysis step is conducted in countercurrent with an acid solution, being that acids such as sulphuric, nitric, phosphoric and hydrochloric can be used.

65. Process for obtaining sugars by acid hydrolysis of cellulosic and lignocellulosic materials according to claim 64 characterized wherein it is employed preferably sulphuric acid or nitric acid.

66. Process for obtaining sugars by acid hydrolysis of cellulosic and lignocellulosic materials according to claim 64 characterized wherein the acid concentrations vary from around 0.2 to around 4.0 g/L for a residence time between 2 and 40 minutes.

67. Process for obtaining sugars by acid hydrolysis of cellulosic and lignocellulosic materials according to claim 45 characterized wherein the acid concentrations vary from around 0.2 to around 4.0 g/L for a residence time between 2 and 40 minutes.

68. Process for obtaining sugars by acid hydrolysis of cellulosic and lignocellulosic materials according to claim 64 characterized wherein the temperature in the cellulose hydrolysis step is between around 130 and around 250° C., preferably between around 130 and around 200° C.

69. Process for obtaining sugars by acid hydrolysis of cellulosic and lignocellulosic materials according to claim 45 characterized wherein the temperature in the cellulose hydrolysis step is between around 130 and around 250° C., preferably between around 130 and around 200° C.

70. Process for obtaining sugars by acid hydrolysis of cellulosic and lignocellulosic materials according to claim 45 characterized wherein occurs washing water injection or a diluted sugar solution in countercurrent of the residual material obtained after the cellulose hydrolysis before removing the referred residual reactor material, in such flowing that, apart from concentration of sugar present in the solution that leaves the cellulose hydrolysis area, is between around 5 and around 35% in weight.
